(19) United States
(12) Patent Application Publication
(10) Pub. No.: US 2014/0254990 A1
(43) Pub. Date: Sep. 11, 2014

(54) OPTICAL CONNECTOR AND METHOD OF FORMING PLUG USING THE OPTICAL CONNECTOR

(71) Applicant: Hirose Electric Co., Ltd., Tokyo (JP)

(72) Inventors: Yoshiyuki HIYAMA, Tokyo (JP); Shinichi MATSUMOTO, Tokyo (JP)

(73) Assignee: Hirose Electric Co., Ltd., Tokyo (JP)

(21) Appl. No.: 14/198,624

(22) Filed: Mar. 6, 2014

(30) Foreign Application Priority Data
Mar. 7, 2013 (JP) 2013-045016

(51) Int. Cl. G02B 6/38

(52) U.S. Cl. CPC G02B 6/3853
USPC 385/84; 29/428

(57) ABSTRACT

An optical fiber insertion unit includes a ferrule; a lens sleeve having a lens at a front end portion thereof and a ferrule insertion opening portion at a rear end portion thereof for inserting the ferrule; and a refractive index matching portion disposed between the ferrule and the lens sleeve. The refractive index matching portion is filled with a refractive index matching material so that the refractive index adjusting agent contacts with at least the lens.

### BACKGROUND OF THE INVENTION AND RELATED ART STATEMENT

The present invention relates to an optical connector, and a method of connecting an optical fiber to the optical connector on-site such as a site of optical fiber-lying work.

Generally speaking, at a factory of producing an optical fiber cable having an optical connector at an end part thereof, first, the optical fiber is cut into a standard length in advance. Afterward, in order to reduce a connection loss due to roughness of an end surface of the optical fiber, the end surface of the optical fiber is subjected to a polishing process. On the other hand, at an optical fiber-lying site, since the lengths of the optical fibers to be used may vary according to the optical fiber-lying site, each optical fiber is cut into a specific length each time, rather than using the optical fiber already cut in the standard length at the factory. In this case, it is difficult to apply the polishing process to the optical fiber when the optical fiber is cut in the specific length at the fiber-lying site without equipment furnished in the factory.

According to a conventional technique, for example, as described in Japanese Patent Application Publication No. 2012-68672 (Patent Reference 1), in a step of abutting and connecting end surfaces of optical fibers, a refractive index matching material is used instead of a process of treating an end surface of the optical fiber. Accordingly, it is possible to reduce the connection loss due to reflected light or scattered light without polishing the end surfaces of the optical fibers.

It should be noted that Japanese Patent Application Publication No. 2004-61671 (Patent Reference 2) and Japanese Patent Application Publication No. 05-113519 (Patent Reference 3) have also described the conventional technique for preventing the reflection and the connection loss using the refractive index matching material.

In addition, as described in Japanese Patent Application Publication No. 2012-68672 (Patent Reference 1), according to the conventional onsite wire-connecting method for the optical fibers, a ferrule having an optical fiber therein is used. Accordingly, a rear end surface of the optical fiber provided in the ferrule is abutted and connected to another external optical fiber via a refractive index matching material.
Patent Reference 1: Japanese Patent Application Publication No. 2012-68672
Patent Reference 2: Japanese Patent Application Publication No. 2004-61671
Patent Reference 3: Japanese Patent Application Publication No. 05-113519

In the conventional onsite wire-connecting method for the optical fibers, however, when the ferrule is produced, it is necessary to enclose the optical fiber therein in advance, thereby increasing the manufacturing cost. In addition, the optical fiber is already enclosed in the ferrule. Accordingly, it is necessary to carefully handle the ferrule at the optical fiber-lying site. Furthermore, it is difficult to apply the refractive index matching material on an end surface of the ferrule. Accordingly, when the ferrule is produced, it also is necessary to polish an end surface of the optical fiber on the front end side thereof, thereby increasing the manufacturing cost.

In order to solve the problems of the conventional technique described above, an object of the present invention is to provide an optical connector having an optical fiber insertion unit having a structure that does not require having an optical fiber in a ferrule in advance. Further, another object of the present invention is to provide a method of onsite wire-connecting method using the optical connector. More specifically, according to the invention, an object of the present invention is to provide an optical connector having an optical fiber insertion unit composed of a ferrule and a lens sleeve suitable for onsite wire connection of the optical fiber. Further, another object of the present invention is to provide an onsite wire-connecting method of connecting the optical fiber using the optical connector without applying a polishing process to an end surface of the optical fiber.

Further objects and advantages of the present invention will be apparent from the following description of the present invention.

### SUMMARY OF THE PRESENT INVENTION

In order to attain the objects described above, according to a first aspect of the present invention, an optical fiber insertion unit includes a ferrule and a lens sleeve, which has a lens at a front end part thereof and a ferrule insertion opening for inserting the ferrule on a rear part thereof, in which there is provided a refractive index matching material on a front end part of the ferrule, and the ferrule is inserted to the lens sleeve from the ferrule insertion opening till the refractive index matching material contacts with at least the lens.

According to a second aspect of the present invention, in the optical fiber insertion unit, the ferrule and the lens sleeve may be formed of different materials having different coefficients of linear expansion and the refractive index matching material attached on the front end part of the ferrule has fluidity.

According to a third aspect of the present invention, an optical connector may include the optical fiber insertion unit; a shell having at least one unit insertion hole for inserting the optical fiber insertion unit and having a split sleeve within the unit insertion hole for securing the lens sleeve of the optical fiber insertion unit; a pressing plate having a passing hole that connects to the optical fiber insertion hole of the ferrule of the optical fiber insertion unit; and a connector sleeve.

According to a fourth aspect of the present invention, the optical connector may include an elastic body for pressing the optical fiber insertion unit inserted in the unit insertion hole into the unit insertion hole by an elastic force between the flange of the optical fiber insertion unit and the pressing plate.

According to a fifth aspect of the present invention, the optical connector may be used to form a plug connected with the optical fiber at an optical fiber-lying site. A onsite wire-connecting method of forming a plug that includes the optical connector of the present invention, a cord collar, and a fastening hardware includes a step of putting an optical fiber cable through inside the fastening hardware and the cord collar; a step of inserting a fiber core wire of the optical fiber cable in the ferrule of the optical fiber insertion unit through the optical fiber insertion hole of the passing hole of the pressing plate and the ferrule; and a step for connecting the cord collar to the optical connector and securing the cord tube and the optical fiber cable with the fastening hardware.

According to a sixth aspect of the present invention, in the onsite wire-connecting method for forming the plug, in the step of inserting the fiber core wire, the bare fiber exposed for the certain length from the fiber core wire is inserted so as to contact with the refractive index matching material at a front end of the ferrule, and in the step of securing the optical fiber cable, the fiber core wire is secured inside of the ferrule with an adhesive applied on a surface of the fiber core wire.

According to the present invention, the optical fiber insertion unit has a simple configuration that is composed of the ferrule and the lens sleeve, and it is not necessary to have the optical fiber in the ferrule in advance as in the conventional technique. Further, it is not necessary to perform the step of polishing an end surface of the optical fiber, so that it is possible to reduce the manufacturing cost of the optical fiber.

Furthermore, according to the present invention, the refractive index matching material applied at the front end of the ferrule enters a gap formed between the ferrule and the lens sleeve. Accordingly, it is possible to prevent the connection loss between the end of the optical fiber and the lens. Moreover, the ferrule and the lens sleeve are formed of the different materials. Accordingly, even when heat is applied on the optical fiber, and the gap between the end portion of the optical fiber and the lens is widened due to the difference in the coefficients of linear expansion of the different materials, the refractive index matching material enters the widened gap, so that the optical fiber insertion unit of the present invention can also deal with the widening of the gap possibly occur later.

In addition, according to the present invention, the optical connector having the optical fiber insertion unit does not include the optical fiber to be connected. Accordingly, there is no risk of accidentally damaging the optical fiber to be connected.

Furthermore, according to the present invention, in the onsite wire-connecting method using the optical connector, at the optical fiber lying site, it is not necessary to polish the end surface of the front end part (i.e., a bare fiber) of the optical fiber core wire exposed from the optical fiber cable that is cut into a suitable length. Rather, the optical fiber core wire is simply inserted into the optical fiber insertion unit within the optical connector. Accordingly, it is possible to easily connect the optical fiber cable to the optical connector. Accordingly, it is possible to significantly reduce the onsite work steps.

### BRIEF DESCRIPTION OF THE DRAWINGS

FIGS. 1(a) and 1(b) are views showing an optical fiber insertion unit according to an embodiment of the present invention, wherein FIG. 1 (a) is a side view showing the optical fiber insertion unit, and FIG. 1 (b) is a side sectional view showing the optical fiber insertion unit taken along a line A-A in FIG. 1(a);

FIGS. 2(a) to 2(d) are sectional views showing a ferrule and a lens sleeve of the optical fiber insertion unit according to the embodiment of the present invention;

FIG. 3 is a sectional view showing an optical connector equipped with the optical fiber insertion unit therein according to the embodiment of the present invention;

FIG. 4 shows an optical fiber before the optical fiber is connected to the optical connector according to the embodiment of the present invention;

FIGS. 5(a) and 5(b) are views showing the optical connector in a state that a tip of a fiber core wire is inserted in the ferrule provided inside the optical connector according to the embodiment of the present invention, wherein FIG. 5 (a) is a side sectional view showing the optical connector and the optical fiber, and FIG. 5 (b) is a side view showing the optical connector and the optical fiber;

FIG. 6 is a perspective view showing a plug including the optical connector and a receptacle according to the embodiment of the present invention; and

FIG. 7 is a sectional view showing the optical connector in a state that the optical connector contained in the plug is connected to the receptacle.

### DETAILED DESCRIPTION OF THE PREFERRED EMBODIMENTS

Hereunder, an embodiment of the present invention will be described with reference to the accompanying drawings. Here, in any of those drawings for describing embodiment of the present invention, the same reference numerals are basically used for the same members and repetitive explanation is omitted.

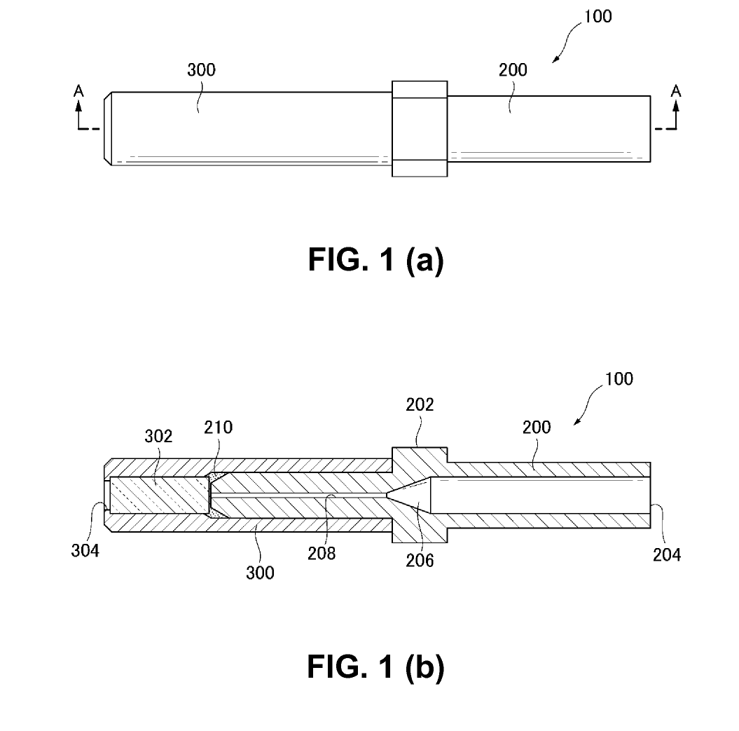

FIGS. 1(a) and 1(b) show an optical fiber insertion unit 100 according to an embodiment of the present invention. As shown in FIG. 1(a), the optical fiber insertion unit 100 is composed of a ferrule 200 and a lens sleeve 300. FIG. 1(b) is a sectional view of the optical fiber insertion unit 100 taken along the line A-A in FIG. 1(a).

As shown in FIGS. 1(a) and 1(b), the ferrule 200 has a cylindrical shape. Further, the ferrule 200 has a flange 202 in a center part on an outer side thereof, and an optical fiber insertion hole 204 in an inner side thereof for inserting an optical fiber in the ferrule 200. Further, the ferrule 200 has an optical fiber guide surface 206 having a tapered shape (e.g., conical shape) for guiding a tip (bare fiber) of the optical fiber to an end part of the ferrule 200, and a bare fiber insertion hole 208 for inserting a bare fiber therein. At an end of the ferrule 200, a refractive index matching material 210 is attached in order to prevent connection loss of the optical fiber. The lens sleeve 300 has a cylindrical shape, and includes a lens 302.

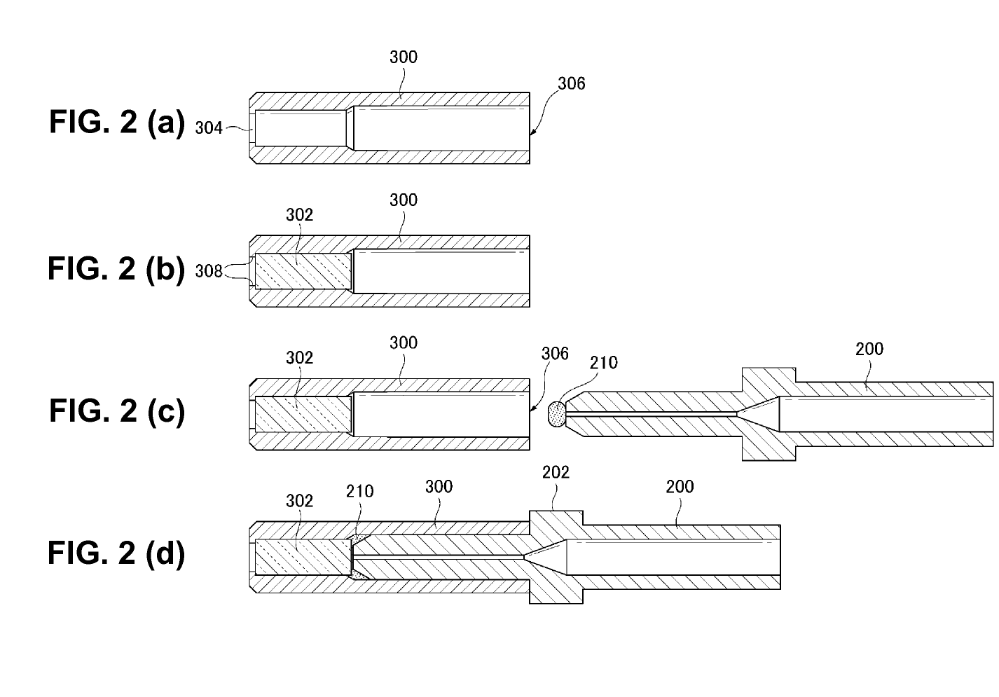

FIGS. 2(a) to 2(d) are sectional views of the ferrule 200 and the lens sleeve 300 that compose the optical fiber insertion unit 100 according to the embodiment of the present invention, and show how to assemble the optical fiber insertion unit 100 using the ferrule 200 and the lens sleeve 300. Here, the ferrule 200 and the lens sleeve 300 are made of different materials having different coefficients of linear expansion. According to one embodiment, the ferrule 200 is formed from metal such as zirconium, whereas the lens sleeve 300 is formed from another metal such as stainless steel.

FIG. 2(a) is a sectional view of the lens sleeve 300, and has a light passing hole 304 at an end thereof and a ferrule insertion opening 306 at an end on the other side thereof. An inner-side end portion of the lens sleeve 300 has a smaller diameter than that of the ferrule insertion opening 306, and as shown in FIG. 2(b), into the end portion, fitted is a lens 302. Upon fitting the lens 302 therein, with a lens locking section 308 formed at an edge of the light passing hole 304, the lens 302 is positioned and secured.

In the embodiment, when light signals are sent from the optical fiber, the lens 302 converts the lights from the optical fiber with one fourth of sinusoidal wave, so that it is possible to widen the light emitted from the light passing hole 304. The widened light is collected with a lens at a connecting section of an optical connector (receptacle), which is a receiving side, so that it is possible to reduce the connection loss due to axial displacement of end surfaces among optical fibers and to achieve high coupling efficiency. In addition, refractive index of the lens 302 is similar to that of glass, and for example, it is 1.45 to 1.46.

As shown in FIG. 2(c), with the refractive index matching material 210 is applied at the end of the ferrule 200, the ferrule 200 is inserted from the ferrule insertion opening 306 to inside of the lens sleeve 300. The refractive index matching material 210 has similar refractive index to that of the optical fiber and the lens 302.

For example, the refractive index of the refractive index matching material 210 is 1.4 to 1.5. In addition, the refractive index matching material 210 is a material having silicone-like or paraffin-like fluidity. According to one embodiment, the refractive index matching material 210 is an oil compound having high transparency that is close to that of quartz glass, and has consistency of 300 to 400 (worked penetration at 25° C. by JIS K 2220 Test Method).

As shown in FIG. 2(d), when the ferrule 200 is inserted in the lens sleeve 300, the flange 202 touches an edge of the ferrule insertion opening 306. At this point, the refractive index matching material 210 applied on the end of the ferrule 200 contacts with the lens 302, presses thereon, and then fills the gap between the end of the ferrule 200 and the lens 302. With the refractive index matching material 210 that fills the gap in this way, it is possible to reduce the connection loss of the optical fiber.

In addition, when the ferrule 200 and the lens sleeve 300 are formed from different material having different coefficients of linear expansion, if the optical fiber insertion unit 100 composed of the ferrule 200 and the lens sleeve 300 is heated, there is a problem of widening of the gap between the end of the optical fiber (i.e., the bare fiber) and the lens 302 in comparison with the usual state thereof due to the difference in the coefficients of linear expansion of different materials. However, since the refractive index matching material 210 around the end of the ferrule 200 has fluidity, the refractive index matching material 210 enters the widened gap, so that it fills even the gap that could be formed later. In other words, even when the optical fiber insertion unit 100 is heated, there is always the refractive index matching material 210 between the bare fiber and the lens 302, so that it is possible to prevent the connection loss of the optical fiber due to influence of heat.

Here, there may be influence from expansion by heat between the ferrule 200 and the bare fiber inserted in the bare fiber insertion hole 208 in the ferrule 200. However, generally speaking, the ferrule 200 and the bare fiber are made from the same material (e.g., zirconium), so that they have generally the same coefficient of linear expansion. Therefore, there is no adverse influence from the thermal stress between the ferrule 200 and the bare fiber.

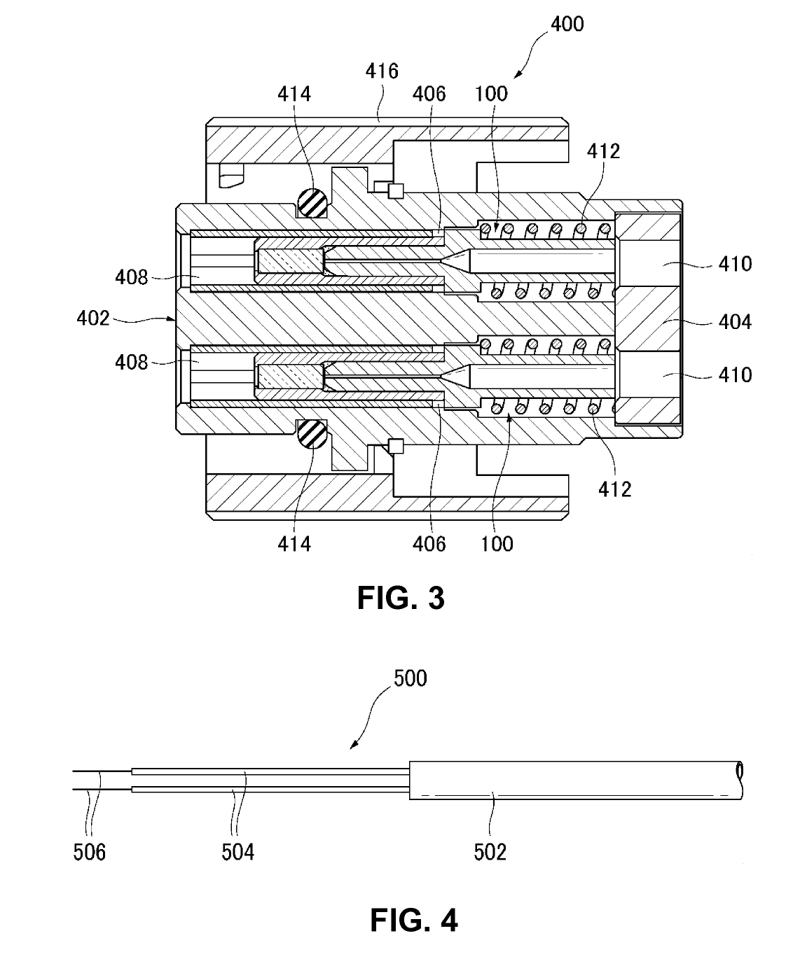

FIG. 3 shows an optical connector 400 according to an embodiment of the present invention, and is a sectional view of the optical connector 400 including two optical fiber insertion units 100. The optical connector 400 includes a shell 402 and a pressing plate 404. On the shell 402, there is provided a unit insertion hole 406 for inserting the optical fiber insertion unit 100. Inside the unit insertion hole 406, there is provided a split sleeve 408 for securing the position of the end (i.e., lens sleeve 300) of the optical fiber insertion unit 100.

According to the embodiment illustrated in FIG. 3, into the two unit insertion holes, the two optical fiber insertion units 100 are inserted and secured therein with the pressing plate 404. On the pressing plate 404, there are provided passing holes 410 that connect to the optical fiber insertion hole 204 and are used for putting the optical fibers therethrough. Each optical fiber is inserted in the optical fiber insertion unit 100 in the optical connector 400 via the passing hole 410 and the optical fiber insertion hole 204, and is tightly secured with a cord collar and a fastening hardware so as not to come off.

Although it is not necessary for forming the optical connector 400, it is also possible to provide an elastic body between the flange 202 of the ferrule 200 and the pressing plate 404 in order to energize the optical fiber insertion unit 100 towards the end thereof. According to the embodiment shown in FIG. 3, there are provided energizing springs 412 as such elastic body. With the energizing springs 412 energize the optical fiber insertion units 100 towards the end of the optical connector 400, when the optical connector 400 is connected to a receptacle, it is possible to keep the state of the end part of each optical fiber insertion unit 100 (lens sleeve 300) being crimped on the connecting section of the receptacle.

Furthermore, according to the embodiment of FIG. 3, there is provided a waterproof ring 414 on the outer side of the end section of the shell 402 for connecting to the receptacle. On the outer side of the shell 402, there is provided a connector sleeve 416 for fitting to the receptacle.

FIG. 4 shows an optical fiber 500 before it is connected to the optical connector 400. According to the embodiment of the present invention, the optical fiber 500 includes a cable 502 covered with outer coating, a fiber core wire 504 exposed from the outer coating of the cable 502, and a bare fiber 506 exposed from the outer coating of the fiber core wire 504, respectively. The optical fiber 500 may be cut into suitable lengths at a wire-lying site. The outer coatings of each cable 502 and each fiber core wire 504 may be cut into certain lengths with special cutting tool and then removed.

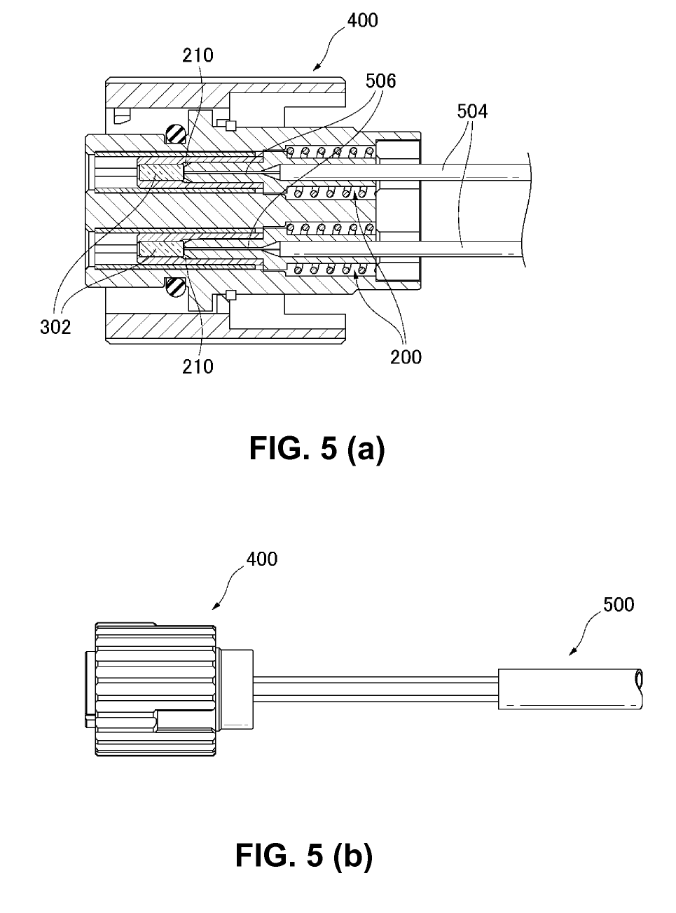

FIGS. 5(a) and 5(b) shows the optical connector 400 in a state where the end portions of the fiber core wires 504 are inserted in the ferrules 200 provided in the optical connector 400.

According to the embodiment of the present invention, the end surface of each bare fiber 506 passes through the bare fiber insertion hole 208 and reaches the refractive index matching material 210 attached on the end portion of each ferrule 200 as shown in the sectional view of FIG. 5(a). The end surface of each bare fiber 506 can suitably transmit light (light signals) from the optical fiber 500 to the lens 302, by contacting with the refractive index matching material 210, so that it is possible to achieve reduction of the connection loss. Therefore, at an optical fiber-lying site, it is possible to easily connect to the optical fiber 400 without polishing the end surfaces of the optical fibers 500 (i.e., end surfaces of the bare fibers 506).

Here, at the wire-lying site, if the optical fiber 500 is cut into suitable lengths, generally, it is not possible to have polishing equipment in the site, so that the end surfaces of the bare fibers 506 would not be polished. However, when the optical connector 400 and the optical fiber 500 are connected at a factory that is well furnished with equipment, needless to say, it is possible to polish the end surface of the bare fiber 506.

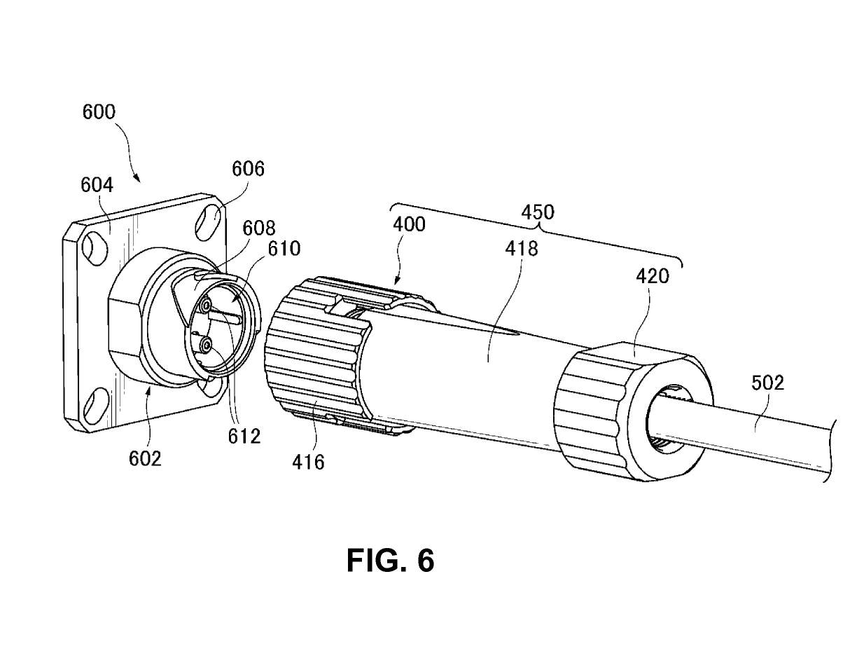

In the onsite wire-connecting method for an optical connector according to the embodiment of the present invention, the optical fiber 500 is cut into suitable lengths, the fiber core wires 504 are exposed from the optical fiber cable 502, and then the bare fibers 506 are exposed from the fiber core wires 504. Then, as shown in FIG. 6, putting the optical fiber 500 into the fastening hardware 420 and the cord collar 418 as shown in FIG. 6 in advance, the optical fiber 500 is inserted in the optical connector 400 via the passing holes 410 and the optical fiber insertion holes 204 as shown in FIG. 5(a).

As a result, the state is as shown in FIG. 5(b). In order to protect the fiber core wires 504, putting the cord collar 418, which was mounted in advance, to the optical connector 400 so as to couple thereto, and further in order to keep the optical fiber 500 from not coming off, the fastening hardware 420 is put at the end of the cord color 418 to couple thereto, and secured by fastening the outer coating of the optical fiber cable 502. As described above, with the simple steps, it is possible to make a plug 450 as shown in FIG. 6 at wire-lying site.

In addition, it is also possible to apply adhesive on the outer coating of the fiber core wires 504, and upon inserting the optical fiber 500 in the optical connector 400, the outer coating of the fiber core wires 504 and inside of the ferrules 200 become adhered to each other with the adhesive, so that it is possible to prevent the optical fiber 500 from coming off during plug 450 making work. Moreover, providing a securing screw to prevent loosening at the coupling part of the cord collar 418 that is to be fitted and coupled in the optical connector 400, and fastening the securing screw after coupling, it is possible to prevent loosening of the cord collar 418. Similarly, it is also possible to provide a securing screw for prevent loosening in the fastening hardware 420 to be fitted coupled to an end of the cord collar 418.

FIG. 6 shows the plug 450 and the receptacle 600, for connecting an optical fiber, according to the embodiment of the present invention. As described above, the plug 450 is made by connecting the optical connector 400 and the optical fiber 500 by an onsite wire-connecting method as described above, and composed of the optical connector 400, the cord collar 418, and the fastening hardware 420.

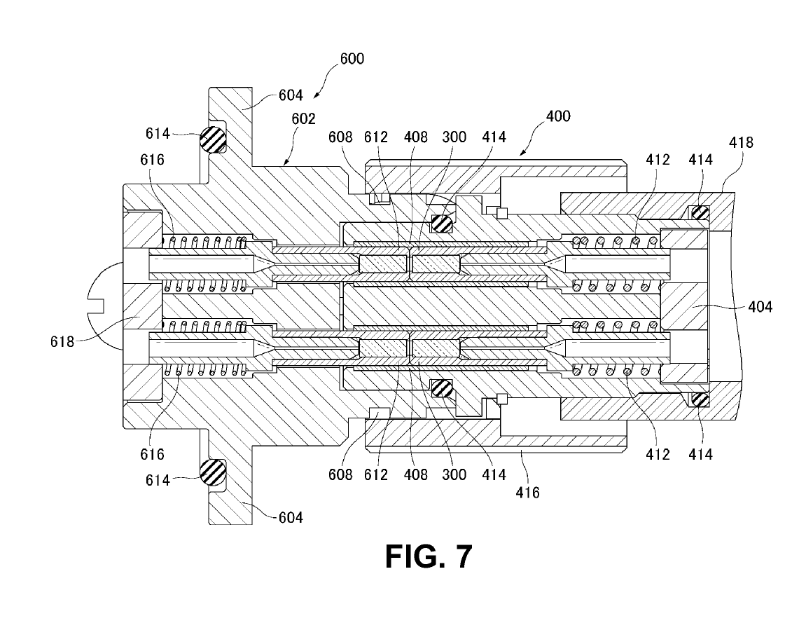

The receptacle 600 includes a shell 602 to put the shell 402 of the optical connector 400 therein; a flange 604 and mounting holes 606 for securing the receptacle 600 onto a wall or the like; a locking groove 608 for securing the connection by fastening the connector sleeve 416 upon connecting the optical connector 400, which composes the plug 450, to the receptacle 600; a fitting opening 610 for fitting to the optical connector 400, and a connecting section 612 for abutting to the lens sleeve 300 within the optical connector 400 and connect thereto. Referring to the sectional view of the receptacle 600 shown in FIG. 7, the receptacle 600 further includes a waterproof ring 614, energizing springs 616, which are elastic bodies to energize the connecting sections 612 towards the end thereof, and a pressing plate 618 for pressing the energizing springs 616. In addition, each connecting section 612 is equivalent to the lens sleeve 300, and the whole structure including the connecting section 612 is similar to that of the optical fiber insertion unit 100.

FIG. 7 shows a state where the optical connector 400 that composes the plug 450 is connected to the receptacle 600. By twisting the connector sleeve 416, a tab provided on an inner side is fitted in the locking groove 608, and thereby it is possible to secure the connection between the optical connector 400 of the plug 450 and the receptacle 600.

Upon connecting the optical connector 400 and the receptacle 600, the connecting section 612 is inserted in the split sleeve 408 of the optical connector 400, and its end comes to contact with ends of the lens sleeves 300 of the optical connector 400. At this point, with the energizing springs 616 provided between the connecting sections 612 on a side of the receptacle 600 and the pressing plate 618, the connecting section 612 is energized towards the end, and similarly with the energizing springs 412 provided between the lens sleeves 300 provided on a side of the plug 450 and the pressing plate 404, the lens sleeves 300 are also energized towards the end thereof.

As a result, the end of the connecting section 612 and the end of the lens sleeve 300 contact to each other and become crimped to each other. Therefore, since those ends are in state of being crimped, it is possible to prevent formation of a big gap, which would cause connection loss between the lenses provided at their respective ends.

The optical connector of the present invention may be applicable upon making a plug by connecting an optical fiber. In addition, an onsite wire-connecting method for an optical connector according to the present invention is applicable in wire-connecting work to connect an optical fiber without polishing work of the end surface of the optical fiber, using the optical fiber of the present invention in an optical fiber-lying work site.

The disclosure of Japanese Patent Applications No. 2013-045016, filed on Mar. 7, 2013, is incorporated in the application by reference.

While the present invention has been explained with reference to the specific embodiments of the present invention, the explanation is illustrative and the present invention is limited only by the appended claims.

What is claimed is:

1. An optical fiber insertion unit, comprising:
a ferrule;
a lens sleeve having a lens at a front end portion thereof and a ferrule insertion opening portion at a rear end portion thereof for inserting the ferrule; and
a refractive index matching portion disposed between the ferrule and the lens sleeve,
wherein said refractive index matching portion is filled with a refractive index matching material so that the refractive index adjusting agent contacts with at least the lens.

2. The optical fiber insertion unit according to claim 1, wherein said ferrule is formed of a first material,
said lens sleeve is formed of a second material having a linear expansion coefficient different from that of the first material, and
said refractive index matching material exhibits fluidity.

3. An optical connector, comprising:
the optical fiber insertion unit according to claim 1;
a shell having a unit insertion hole and a separation sleeve for holding the lens sleeve of the optical fiber insertion unit;
a holding plate having a through hole corresponding to the ferrule insertion opening portion of the optical fiber insertion unit; and
a connector sleeve.

4. The optical connector according to claim 3, further comprising an elastic member disposed between the holding plate and a flange of the optical fiber insertion unit for pressing the optical fiber insertion unit into the unit insertion hole.

5. A method of forming a plug including the optical connector according to claim 3, a code ring, and a tightening member, comprising the steps of:
passing an optical fiber cable through the tightening member and the code ring;
inserting a fiber core cable of the optical fiber cable into the ferrule of the optical fiber insertion unit through the through hole of the holding plate and the optical fiber insertion hole of the ferrule; and
connecting the code ring to the optical connector to fix the code ring and the optical fiber cable with the tightening member.

6. The method of forming the plug according to claim 5, wherein, in the step of inserting the fiber core cable of the optical fiber cable, said fiber core cable of the optical fiber cable is inserted so that a bare fiber exposed from the fiber core cable by a specific length contacts with the refractive index matching material in the refractive index matching portion, and
in the step of fixing the optical fiber cable, said optical fiber cable is fixed so that the fiber core cable is fixed inside the ferrule with an adhesive attached to a surface of the fiber core cable when the fiber core cable is inserted into the ferrule.
